(19) United States
(12) Patent Application Publication
(10) Pub. No.: US 2018/0037016 A1
(43) Pub. Date: Feb. 8, 2018

(54) DISPLAY PROTECTION FILM ATTATCHING CASE FOR MOBILE TERMINAL

(71) Applicant: Whitestone Co., Ltd., Cheonan-si (KR)

(72) Inventors: YANGGYU KIM, Seongnam-si (KR); DONGSU NOH, Seongnam-si (KR); CHANHYUN PARK, Suwon-si (KR); SOONGWON LEE, Cheonan-si (KR); YUNGYU LEE, Cheonan-si (KR)

(21) Appl. No.: 15/226,665

(22) Filed: Aug. 2, 2016

(51) Int. Cl. B32B 37/00; H04B 1/3888

(52) U.S. Cl. CPC B32B 37/0053; H04B 1/3888; H04W 88/02

(57) ABSTRACT

Disclosed is a case for attaching a screen protector film for a mobile terminal. The case for attaching a screen protector film for a mobile terminal includes: a film housing that has a film seat for keeping a screen protector including a separation film and a screen protector film that is separated from the separation film to be attached to a screen of a mobile terminal; and a movable member that is coupled to and separated from the film housing by moving in a movement direction parallel with the longitudinal direction of the screen protector and has a terminal seat disposed perpendicular to the movement direction and corresponding to the upper end or the lower end of a mobile terminal, in which the movable member is connected to the screen protector film at a predetermined area around the terminal seat.

### BACKGROUND OF THE INVENTION

### 1. Field of the Invention

The present invention relates to a case for attaching a screen protector film for a mobile terminal and, more particularly, to a case that allows for quick and easy attachment of a screen protector film for a mobile terminal.

### 2. Description of the Related Art

The screens of smart-phone and tablet PCs that are recently widely used are more expensive and larger than those of common mobile phones, so screen protector films are attached and used to prevent scratches.

Screen protector films are generally composed of a transparent plastic film having an adhesive bottom and a separation film detachably disposed on the plastic film to protect the adhesive bottom.

In common mobile phones, the screens are a small square or rectangle and, a keypad, a speaker, and a camera are disposed not on, but around the screens, so a screen protector film can he easily attached by folding and separating the separation film.

In smartphones or tablet PCs that have been popularized and widely used in recent years, a camera lens, a speaker, a home button, and various sensors are disposed in the screens, so screen protector films are manufactured and sold with the portions for the camera lens etc. are cut and bored to be appropriately attached.

When attaching a screen protector film to a smartphone or a tablet PC, a user should put the cut and bored portions over the camera lens, a speaker, a home button, and various sensors.

However, the screens of the smartphones and tablet PCs are larger than those of common mobile phones, and bored portions and cut portions are positioned over and under each other, so it is difficult to attach a screen protector film at an exact position at a time.

In particular, one label is attached to the separation film on the rear sides of screen protector films that are on the market, so a user has to holds and pull the label in one direction with a screen protector film on a screen to separate the separation film, whereby it is difficult to attach the screen protector film at an exact position inside the screen.

If a screen protector film is not attached at an exact position at a time, the screen protector film is attached aslant. When a screen protector film attached aslant is detached, dirt adheres to the adhesive side or the adhesive side is damaged by fingerprints or trace of fingers, so transparency is deteriorated. Further, when the adhesive side is damaged, the adhesion is deteriorated.

Accordingly, it is required to exactly attach a screen protector film at a time to a mobile terminal, so it is very difficult to attach a screen protector film. Further, when a screen protector film is not attached at a time, the screen protector film is damaged and new screen protector films are needed in many cases.

### Prior Art Document

[Patent Document] Korean Patent No. 10-1149573

### SUMMARY OF THE INVENTION

An object of the present invention is to provide a case for attaching a screen protector film for a mobile terminal, the case allowing for quickly sequentially removing dirt on the screen of a mobile terminal and attaching a screen protector film to the screen without a failure, and reducing the cost for additionally purchasing a new screen protector film when it is failed to attach a screen protector film.

According to an aspect of the present invention, a case for attaching a screen protector film for a mobile terminal includes: a film housing that has a film seat for keeping a screen protector including a separation film and a screen protector film that is separated from the separation film to toe attached to a screen of a mobile terminal; and a movable member that is coupled to and separated from the film housing by moving in a movement direction parallel with the longitudinal direction of the screen protector and has a terminal seat disposed perpendicular to the movement direction and corresponding to the upper end or the lower end of a mobile terminal, in which the movable member is connected to the screen protector film at a predetermined area around the terminal seat.

The terminal seat may have a pushing protrusion formed in the shape of a plate corresponding to the upper-end or the lower end of a mobile terminal.

The terminal seat may have: a curved portion that is formed in a shape corresponding to the upper end or the lower end of a mobile terminal and keeps the upper end or the lower end of the mobile terminal; a plate-shaped pushing protrusion that perpendicularly protrudes from an end of the curved portion, is disposed at the center of the curved portion, and corresponds to the middle portion of the upper end or the lower end of the mobile terminal; and a pair of plate-shaped guides that perpendicularly protrudes from the end of the curved portion at the left and right sides of the pushing protrusion, and corresponds to a corner of the upper end or the lower end of the mobile terminal.

The film housing may have: a plate-shaped bottom that has the film seat on the inner side; and sides that are perpendicular to the bottom, the movable member has a plate-shaped cover portion having the terminal seat at an end perpendicular to the movement direction, and the movable member moves in the movement direction with the edges of the cover portion on the sides.

The film housing may have a pair of guide walls disposed close to a short side of the bottom and spaced at a predetermined distance to face each other, and the movable member may have a pair of sliding walls extending a predetermined distance on the outer side of the cover portion and sliding in the longitudinal direction of the screen protector in contact with the pair of guide walls.

The pair of guide walls may have guide grooves formed on the surface being in contact with the pair of sliding walls, and the pair of sliding walls may have guide, protrusions formed on surfaces being in contact with the pair of guide walls and fitted in the guide grooves.

The movable member may further have a film-pressing side disposed between the pair of sliding walls and facing the film seat.

The movable member may further have a stopper that restricts movement of the movable member when the movable member is moved to be coupled to the film housing, and the stopper may be disposed opposite to the terminal seat.

The stopper may protrude from the film-pressing side, and the film housing may further have a stopper groove that is formed on the inner side of the bottom, to be disposed between the pair of guide walls, to be fitted on the stopper.

The film housing may further have a pair of cover supports disposed close to the film seat and supporting the cover portion of the movable member.

The case may further include a dirt remover coupled to the film housing, close to the film seat.

The film housing may further have a terminal holder that faces the dirt remover and supports a mobile terminal when the mobile terminal is positioned with the upper end or the lower end corresponding to the terminal seat.

The movable member may further have a recession formed concavely in a direction perpendicular to the movement direction.

The film housing may be a rectangular plate having the film seat on the inner side and the movable member may be a rectangular plate having the terminal seat at an end perpendicular to the movement direction.

According to the case for attaching a screen protector film for a mobile terminal, it is possible to quickly sequentially remove dirt on the screen of a mobile terminal and attach a screen protector film to the screen without a failure. Further, it is possible to save the cost for additionally purchasing a new screen protector when it is failed to attach a screen protector film.

### BRIEF DESCRIPTION OF THE DRAWINGS

FIG. 1 is an exploded perspective view showing the configuration of a case for attaching a screen protector film for a mobile terminal according to an embodiment of the present invention.

FIG. 2 is a perspective view showing the inner side of a movable member shown in FIG. 1.

FIG. 3 is a perspective view showing a case when a mobile terminal is placed in a terminal seat to illustrate of a process of using the case for attaching a screen protector film for a mobile terminal according to an embodiment of the present invention.

FIG. 4 is a perspective view showing a case when a screen protector film is separated from a separation film by moving a movable member to illustrate of a process of using the case for attaching a screen protector film for a mobile terminal according to an embodiment of the present invention.

### DETAILED DESCRIPTION OF THE PREFERRED EMBODIMENTS

Hereinafter, a case for attaching a screen protector film for a mobile terminal according to an embodiment of the present invention will be described in detail with reference to the accompanying drawings. The present invention may be modified in various ways and implemented by various embodiments, so that specific embodiments are shown in the drawings and will be described in detail below. However, it is to be understood that the present invention is not limited to the specific exemplary embodiments, but includes ail modifications, equivalents, and substitutions included in the spirit and the scope of the present invention. Like reference numerals are given to like components in the description of the drawings. The sizes of the structures shown in the drawings are enlarged relatively to the real sizes to make the present invention clear.

Terms used in the specification, ‘first’, ‘second’, etc., may be used to describe various components, but the components are not to be construed as being limited to the terms. The terms are used to distinguish one component from another component. For example, the ‘first’ component may be named the ‘second’ component, and vice versa, without departing from the scope of the present invention.

Terms used herein are used only in order to describe specific embodiments rather than limiting the present invention. As used herein, the singular forms are intended to include the plural forms as well, unless the context clearly indicates otherwise. It will be further understood that the terms “comprises,” “comprising,”, “have” and/or “having,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the present invention belongs. It will be further understood that terms used herein should be interpreted as having a meaning that is consistent with their meaning in the context of this specification and the relevant art and will not be interpreted in an idealized or overly formal sense unless expressly so defined herein.

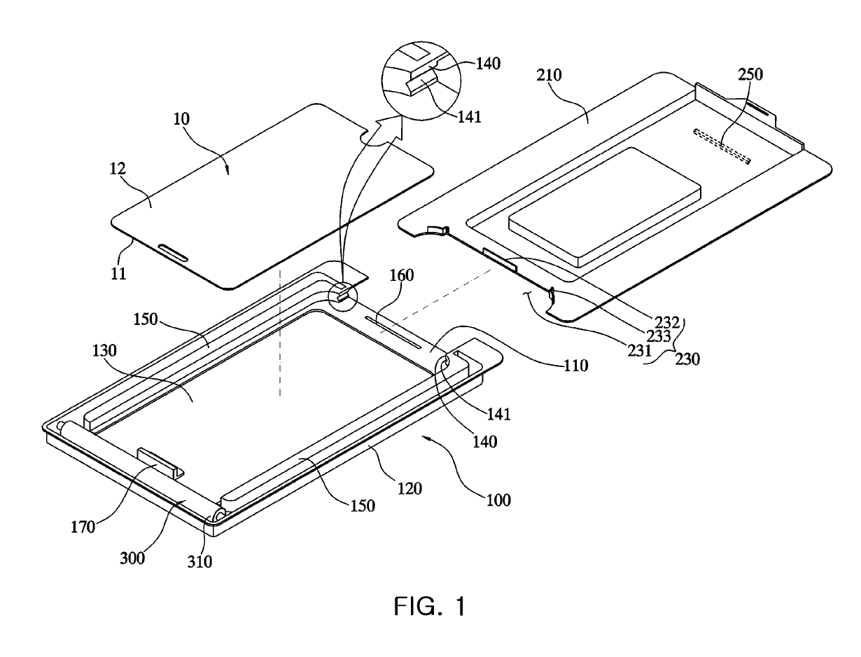

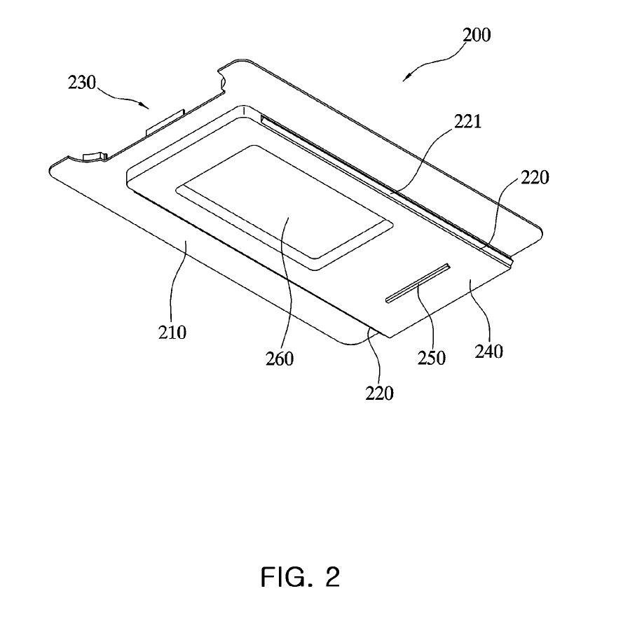

FIG. 1 is an exploded perspective view showing the configuration of a case for attaching a screen protector film for a mobile terminal according to an embodiment of the present invention and FIG. 2 is a perspective view showing the inner side of a movable member shown in FIG. 1.

Referring to FIGS. 1 and 2, a case for attaching a screen protector film for a mobile terminal according to an embodiment of the present invention includes a film housing 100 and a movable member 200.

The film housing 100 provides a space for keeping a screen protector 10. To this end, the film housing 100 may have a bottom 110, sides 120, and a film seat 130. The bottom 100 may be a rectangular plate and the sides 120 may perpendicularly extend from the edges of the bottom 110. The film seat 130 is formed on the inner side of the bottom 110. For example, the film seat 130 may be recessed from the inner side of the bottom 110 to be lower than the inner side of the bottom 110.

The screen protector 10. that is disposed in the film seat 130 may include a separation film 11 and a screen protector film 12 that is separated from the separation film 11 to be attached to the screen of a mobile terminal. The screen protector 10 is kept in the screen seat 130 with the screen protector film 12 up.

The movable member 200 has a cover portion 210 that is combined with the film housing 100 and covers the insides of the sides 120 of the film housing 100. The cover portion 210 may be a rectangular plate that is the same as or larger in size than the bottom 110. The edges of the inner side of the cover portion 210 correspond to the top of the sides 120 of the film housing 100 when the movable member 200 is moved in a predetermined movement direction.

The movable member 200 is slidably coupled to the film housing 100. To this end, the film housing 100 may have a pair of guide walls 140 and the movable member 200 may include a pair of sliding walls 220.

The pair of guide walls 140 may be disposed close to a short side of the bottom 110 of the film housing 100, that is, the upper end of the bottom 110 when the inner side of the bottom 110 is seen from the front. In order to form the pair of guide walls 140, it may be possible to open the inside from the sides 120 by cutting portions of the side 120 of the film housing 100 and form the pair of guide walls 140 at both sides of the open portions of the sides 120. The pair of guide walls 140 is spaced at a predetermined distance to face each other and extend parallel with the longitudinal direction of the bottom 110. The extended length of the pair of guides 140 is not specifically limited and they may be short, as shown in FIG. 1. A guide groove 141 may be formed on the inner sides of the pair of guide walls 140.

The pair of sliding walls 220 protrudes downward from the inner side of the cover portion 210 of the movable member 200 and extends a predetermined distance in the longitudinal direction of the cover portion 210. The pair of sliding wails 220 is spaced at a predetermined distance to face each other. The distance between, the pair of guide walls 140 may be the distance between the guide walls 140. A guide protrusion 221 may be formed on the inner sides of the pair of sliding walls 220. The guide protrusions 221 are inserted in the guide grooves 141 formed on the pair of guide walls 140 to enable the pair of sliding walls 220 to stably slide in contact with the pair of guide walls 140 without separating from the pair of guide walls 140.

By the pair of guide walls 140 and the pair of sliding walls 220, the movable member 200 is coupled to or separated from the film housing 100 by sliding the movable member 200 in a movement direction parallel with the longitudinal direction of the screen protector 10 kept in the film housing 100 and the longitudinal direction of the film housing 100.

When the movable member 200 combined with the film housing 100 is moved to be separated from the film housing 100, the screen protector film 12 of the screen protector 10 kept in the film seat 130 is gradually separated from the separation film 11 to be attached to the screen of a mobile terminal 30. To this end, the movable member 200 has a terminal seat 230 and a predetermined portion around the terminal seat 230 is connected to the screen protector film 12.

The terminal seat 230 is a portion that corresponds to the upper end or the lower end of the mobile terminal 30 and allows the movable member 200 to move in the movement direction when the mobile terminal 30 is pushed toward the terminal seat 230. The terminal seat 230 is positioned at an end perpendicular in the movement direction of the movable member 200, that is, the lower end of the cover portion 210 of the movable member 200. The terminal seat 230 may have a curved portion 231, a pushing projection 232, and a pair of guides 233.

The curved portion 231 can keep the upper end or the lower end of the mobile terminal 30. To this end, the curved portion 231 may be formed in a shape corresponding to the shape of the upper end of the mobile terminal 30. The curved portion 231 may be formed inward from the lower end of the cover portion 210 of the movable member 200.

The pushing protrusion 232 may be a plate perpendicularly protruding from the end of the curved portion 231 and is positioned at the center of the curved portion 231. When the upper end or the lower end of the mobile terminal 30 is inserted in the curved portion 231, the pushing protrusion 232 may corresponding to the center of the upper end or the lower end of the mobile terminal 30.

The pair of guides 233 may be plate perpendicularly protruding from the end of the curved portion 232 and are disposed at the left and right sides from the pushing protrusion 232. When the upper end or the lower end of the mobile terminal 30 is inserted in the curved portion 231, the pair of guides 233 correspond to the corners of the upper end or the lower end of the mobile terminal 30, so they can guide the upper end or the lower end of the mobile terminal 30 to be easily inserted into the curved portion 231.

The areas that are connected to the screen protector film 12 may be the areas between the pushing protrusion 232 and the guides 233. For example, the screen protector film 12 may be connected to the movable member 200 through a sheet-like tag 20 attached to the side opposite to the side with the separation film 11 thereon. In this case, the end of the tag 20 may be attached to the outer side of the cover portion 210 between the pushing protrusion 232 and the guides 233. For example, the tag 20 may be bonded to the outer side of the cover portion 210 by a double-sided tape. As the movable member 200 is moved to be separated from the film housing 100, the tag 20 is pulled, whereby the connected screen protector film 12 can be separated from the separation film 11.

On the other hand, the film housing 100 may further have a pair of cover supports 150 and the movable member 200 may further have a film-pressing side 240.

The pair of cover supports 150 is disposed close to the film seat 130 of the film housing 100 and support the cover portion 210 while the movable member 200 is moved in the movement direction. To this end, the pair of cover supports 150 extends parallel with the movement direction of the movable member 200. For example, the cover supports 150 may extend toward the lower end of the film housing 100 from the pair of guide walls 140. The pair of cover supports 150 may extend the movement distance of the movable member 200 and have a predetermined width. The inner side of the cover portion 210 of the movable member 200 is supported by the cover supports 150.

The film-pressing side 240 presses the screen protector 10 kept in the film seat 130 while the movable member 200 is moved in the movement direction. The film-pressing side 240 may be disposed between the pair of sliding walls 220. For example, the film-pressing side 240 may be a flat surface that can be integrated with the pair of sliding walls 220 by connecting the edges to the ends of the sliding walls 220. In this case, the film-pressing side 240 faces the film seat 130. The film-pressing side 240 is in contact with the inner side of the bottom 110 of the film housing 100 when the movable member 200 is combined with the film housing 100, and accordingly, when the screen protector 10 is placed in the film seat 130, the film-pressing side 240 may can be brought in contact with the screen protector 10.

The movable member 200 may further has a stopper 250 and a recession 260 and the film housing 100 may further have a stopper groove 160.

The stopper 250 restricts movement of the movable member 200 when the movable member 200 is moved to be coupled to the film housing 100. The stopper 250 is formed opposite to the terminal seat 230. For example, the stopper 250 may protrude from the film-pressing side 240, opposite to the terminal seat 230. That is, the stopper 250 is disposed close to the upper end of the movable member 200. The shape of the stopper 250 is not specifically limited, and for example, the cross-section of the stopper 250 may be a right triangle. When the cross-section of the stopper 250 is a right triangle, the vertical side of the right triangle may face the terminal seat 230. The stopper 250 can limit the movement distance of the movable member 250 by corresponding to the upper end of the bottom 110 of the film housing 100 when the movable member 200 is moved to be coupled to the film housing 100.

The recession 260 may be formed concavely perpendicular to the movement direction of the movable member 200. For example, the recession 260 may be formed concavely toward the outer side of the cover portion 210 from the film-pressing side 240. The recession 260 is smaller in area than the film-pressing side 240. A screen cleaner etc. may be stored in the recession 260.

The stopper groove 160 is fitted on the stopper 250. To this end, the stopper groove 160 may have a shape corresponding to the cross-section of the stopper 250. For example, when the stopper 250 has a right triangular cross-section, the stopper groove 160 may also have a right triangular cross-section. The stopper groove 160 may be formed on the inner side of the bottom 110 of the film housing 100, between the pair of guide walls 140 and close to the upper end of the film housing 100.

On the other hand, the case for attaching a screen protector film for a mobile terminal according to an embodiment of the present invention may further include a dirt remover 330 and the film housing 100 may further have a terminal holder 170.

The dirt remover 300 is provided to remove dirt on the screen of the mobile terminal 30 before the screen protector film 12 of the screen protector 10 kept in the film housing 100 is attached. The dirt remover 300 is combined with the film housing 100, close to the film seat 130 and close to the terminal seat 230 of the movable member 200 coupled to the film housing 100. For example, the dirt remover 300 may be a roller. In this case, both ends of the roller may be connected to the sides 120 of the film housing 100 through shafts so that the roller can rotate. An adhesive sheet 310 may be wound on the roller to remove dirt from a screen. When the mobile terminal 30 is put inside the terminal seat 230 of the movable member 200 and then the movable member 200 is moved by pushing the mobile terminal 300, the roller can be rotated by the movement of the mobile terminal 30 and the adhesive sheet 310 can remove dirt on the screen of the mobile terminal 30.

The terminal holder 170 is a portion that supports the mobile terminal 30 when the upper end or the lower end of the mobile terminal 30 is placed inside the terminal seat 230. The terminal holder 170 may be formed on the inner side of the bottom 110 of the film housing 100 to face the dirt remover 300. For example, the terminal holder 170 may have an L-shaped cross-section. In this case, the upper end of the terminal holder 170 may be the same as or smaller in height than the dirt remover 300.

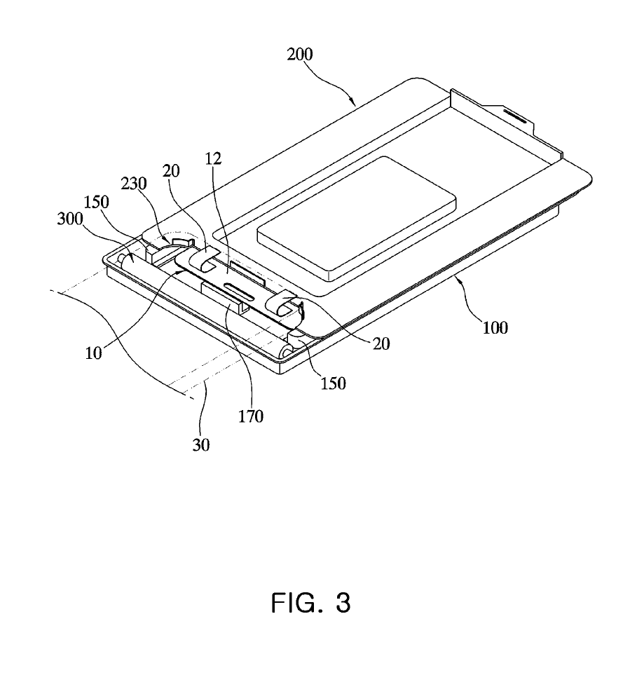

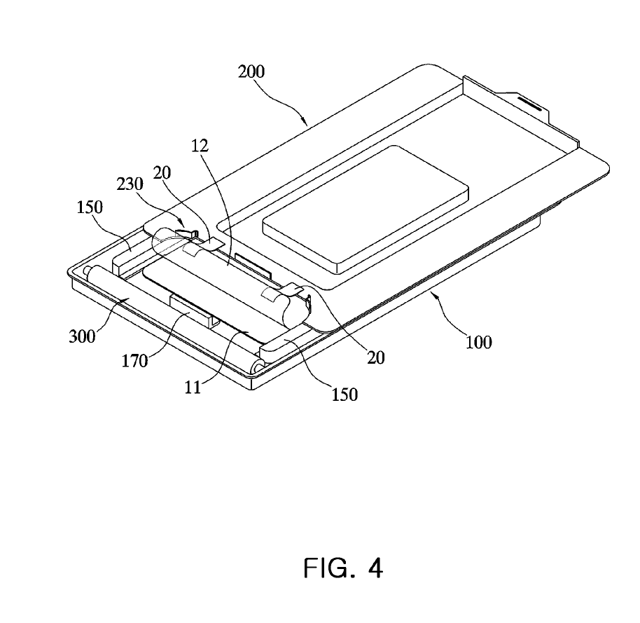

A process of attaching a screen protector film to the screen of a mobile terminal using the case for attaching a screen protector film for a mobile terminal according to an embodiment of the present invention is described hereafter with reference to FIGS. 3 and 4. FIG. 3 is a perspective view showing a case when a mobile terminal is placed in a terminal seat to illustrate of a process of using the case for attaching a screen protector film for a mobile terminal according to an embodiment of the present invention and FIG. 4 is a perspective view showing a case when a screen protector film is separated from a separation film by moving a movable member to illustrate of a process of using the case for attaching a screen protector film for a mobile terminal according to an embodiment of the present invention.

In order to attach a film to the screen of a mobile terminal, first, the movable member 200 is coupled to the film housing 100 with the screen protector 10 in the film seat 130 of the film housing 100, in which the screen protector film 12 of the screen protector 10 is positioned to face the inner side of the cover portion 210 of the movable member 200, the upper end of the screen protector film 12 faces the lower end of the film housing 100, and the lower end of the screen protector film 12 faces the upper end of the film housing 100. The upper end of the screen protector film 12 is connected to the terminal seat 230 of the movable member 200 by the tag 20.

In this state, the upper end of the mobile terminal 30 is moved inside the terminal seat 230 of the movable member 200, as shown in FIG. 3. The upper end of the mobile terminal 30 is kept inside the curved portion 231 of the terminal seat 230, and the pushing protrusion 232 and the pair of guides 233 of the terminal seat 230 is positioned around the upper end of the mobile terminal 30. Further, the terminal holder 170 supports the mobile terminal 30 and the screen of the mobile terminal 30 faces the dirt remover 300.

Next, the movable member 200 is moved to be separated from the film housing 100 by pushing the mobile terminal 30 toward the upper end of the film housing 100. While the mobile terminal 30 and the movable member 200 are moved, the dirt such as dust on the screen of the mobile terminal 30 is removed by the dirt remover 300 and the screen protector film 12 is separated from the separation film 11 and attached to the surface of the screen of the mobile terminal 30, as shown in FIG. 4.

That is, as the mobile terminal 30 is moved, the roller of the dirt remover 300 rotates, and the adhesive sheet 310 wound on the roller removes the dirt such as dust on the screen of the mobile terminal 30. Further, as the movable member 200 is moved and the terminal seat 230 is gradually moved away from the upper end of the screen protector film 12, the upper end of the screen protector film 12 is pulled by the tag 20 attached to the terminal seat 230, whereby the upper end of the screen protector film 12 is separated from the separation film 11. The upper end of the screen protector film 12 separated from the separation film 11 is bent and turned over such that the adhesive side of the screen protector film 12 faces the mobile terminal 30. Further, as the mobile terminal 30 keeps moving, the adhesive side of the screen protector film 12 is attached to the surface of the screen of the mobile terminal 30, whereby the screen protector film 12 is attached to the screen of the mobile terminal 30. In this process, while the movable member 200 is moved, the film-pressing side 240 of the movable member 200 presses the screen protector 10 kept in the film seat 130.

When the movable member 200 reaches the upper end of the film housing 100, the entire surface of the screen protector film 12 is separated from the separation film 11 and attached to the entire screen of the mobile terminal 30.

The case for attaching a screen protector film for a mobile terminal according to an embodiment of the present invention has the following advantages.

First, the screen protector film 12 is attached to the screen of the mobile terminal 30 only by placing the upper end or the lower end of the mobile terminal 30 inside the terminal seat 230 and then moving the movable member 200 by pushing the mobile terminal 30 toward the upper end of the film housing 100, so it is possible to very easily and quickly attach the screen protector film 12 for protecting the screen of the mobile terminal 30. Further, it is possible to attach the screen protector film 12 to the screen of the mobile terminal 30 without a failure in the process of attaching the screen protector film 12 to the screen of the mobile terminal 30.

Second, since the dirt such as dust on the screen of the mobile terminal 30 is removed by the dirt remover 300 before the screen protector film 12 is attached to the screen of the mobile terminal 30, it is possible to attach the screen protector film in a clean state without dirt between the surface of the screen of the mobile terminal 30 and the screen protector film 12 attached to the screen.

Third, since while the movable member 200 is moved, the entire screen protector 10 in the film seat 130 of the film housing 100 is pressed by the film-pressing side 240 in the process of attaching the screen protector film 12 to the screen of the mobile terminal 30 by moving the movable member 200, it is possible to prevent the screen protector 10 from coming off or separating inside the film seat 130. Accordingly, a failure in the process of attaching the screen, protector film 12 due to coming-off or separation of the entire screen protector 10 is prevented.

Consequently, by using the case for attaching a screen protector film for a mobile terminal according to an embodiment of the present invention, it is possible to quickly and sequentially perform the processes of removing dirt on the screen of the mobile terminal 30 and attaching the screen protector film and the process of attaching the screen protector film to the screen of the mobile terminal is simply and quickly performed without a failure. Accordingly, it is possible to save the cost for additionally purchasing a new screen, protector due to a failure of attaching a screen protector film.

On the other hand, the case for attaching a screen protector film for a mobile terminal according to the present invention may be provided in a package to consumers.

That is, the screen protector 10 is put into the film housing 100, a screen cleaner is put into the recession 260 of the movable member 200, and then the stopper 250 on the movable member 200 is fitted into the stopper groove 160 of the film housing 100, whereby the film-pressing side 240 of the movable member 200 presses the screen protector 10 and the movable member 200 covers the inside of the film housing 100 without moving. As described above, it is possible to provide a consumer with a combination of the screen protector 10, the screen cleaner, and the device that can attach the screen protector film 12 of the screen protector 10 by putting the screen protector 10 and the screen cleaner into the case.

On the other hand, though not shown in the figures, the film housing and the movable member may be formed only in the shape of a rectangular plate. In this case, it may be possible to form a first groove having a predetermine depth on a side of the plate that is the film housing, to form a film seat by forming a second groove on the inner side of the first groove, and to form a guide groove parallel with the longitudinal direction of the plate on the inner side of the first groove. Further, it may be possible to form a guide protrusion at an end of a long axis of the plate that is the movable member so that the guide protrusion can slide along the guide groove. Further, in this case, a terminal seat may be formed at the lower end of the plate that is the movable member.

The description of the proposed embodiments is provided for those skilled in the art to use or achieve the present invention. Various modifications from the embodiments may be apparent to those skilled in the art and the common principles defined herein may be applied to other embodiments without departing from the scope of the present invention. Therefore, the present invention is not limited to the embodiments proposed herein and should be construed within the widest range including the principles proposed herein and other new characteristics.

What is claimed is:

1. A case for attaching a screen, protector film for a mobile terminal, the case comprising:
a film housing that has a film seat for keeping a screen protector including a separation film and a screen protector film that is separated from the separation film to be attached to a screen of a mobile terminal; and
a movable member that is coupled to and separated from the film housing by moving in a movement direction parallel with the longitudinal direction of the screen protector and has a terminal seat disposed perpendicular to the movement direction and corresponding to the upper end or the lower end of a mobile terminal,
wherein the movable member is connected to the screen protector film at a predetermined area around the terminal seat.

2. The case of claim 1, wherein the terminal seat has a pushing protrusion formed in the shape of a plate corresponding to the upper end or the lower end of a mobile terminal.

3. The case of claim 1, wherein the terminal seat has:
a curved portion that is formed in a shape corresponding to the upper end or the lower end of a mobile terminal and keeps the upper end or the lower end of the mobile terminal;
a plate shaped pushing protrusion that perpendicularly protrudes from an end of the curved portion, is disposed at the center of the curved portion, and corresponds to the middle portion of the upper end or the lower end of the mobile terminal; and
a pair of plate-shaped guides that perpendicularly protrudes from the end of the curved portion at the left and right sides of the pushing protrusion, and corresponds to a corner of the upper end or the lower end of the mobile terminal.

4. The case of claim 1, wherein the film housing is a rectangular plate having the film seat on the inner side and the movable member is a rectangular plate having the terminal seat at an end perpendicular to the movement direction.

5. The case of claim 1, wherein the film housing has:
a plate-shaped bottom that has the film seat on the inner side, and
sides that are perpendicular to the bottom,
the movable member has a plate-shaped cover portion having the terminal seat at an end perpendicular to the movement direction, and
the movable member moves in the movement direction with the edges of the cover portion on the sides.

6. The case of claim 5, wherein the film housing has a pair of guide walls disposed close to a short side of the bottom and spaced at a predetermined distance to face each other, and
the movable member has a pair of sliding walls extending a predetermined distance on the outer side of the cover portion and sliding in the longitudinal direction of the screen protector in contact with the pair of guide walls.

7. The case of claim 6, wherein the pair of guide walls has guide grooves formed on the surface being in contact with the pair of sliding walls, and
the pair of sliding wails has guide protrusions formed on surfaces being in contact with the pair of guide walls and fitted in the guide grooves.

8. The case of claim 6, wherein the movable member further has a film-pressing side disposed between the pair of sliding walls and facing the film seat.

9. The case of claim 5, wherein the movable member further has a stopper that restricts movement of the movable member when the movable member is moved to be coupled to the film housing, and
the stopper is disposed opposite to the terminal seat.

10. The case of claim 9, wherein the stopper protrudes from the film-pressing side, and
the film housing further has a stopper groove that is formed on the inner side of the bottom, to be disposed between the pair of guide walls, to be fitted on the stopper.

11. The case of claim 5, wherein the film housing further has a pair of cover supports disposed close to the film seat and supporting the cover portion of the movable member.

12. The case of claim 1, further comprising a dirt remover coupled to the film housing, close to the film seat.

13. The case of claim 12, wherein the dirt remover includes a roller having both sides connected to the sides of the film housing through a shaft so that the roller can rotate, and
an adhesive sheet for removing dirt on a screen is attached to the outer side of the roller.

14. The case of claim 12, wherein the film housing further has a terminal holder that faces the dirt remover and supports a mobile terminal when the mobile terminal is positioned with the upper end or the lower end corresponding to the terminal seat.

15. The case of claim 1, wherein the movable member further has a recession formed concavely in a direction perpendicular to the movement direction.
